(19) United States
(12) Patent Application Publication
(10) Pub. No.: US 2008/0008301 A1
(43) Pub. Date: Jan. 10, 2008

(54) NETWORK TELEPHONE DEVICE

(75) Inventor: Ming-Hui Huang, Taipei (TW)

Correspondence Address: ISHIMARU & ZAHRT LLP, 333 W. EL CAMINO REAL, SUITE 330, SUNNYVALE, CA, 94087, US

(73) Assignee: INVENTEC MULTIMEDIA & TELECOM CORPORATION, Taipei (TW)

(21) Appl. No.: 11/668,880

(22) Filed: Jan. 30, 2007

(30) Foreign Application Priority Data
Jun. 22, 2005 (TW) 094120736

(51) Int. Cl. H04M 11/00

(52) U.S. Cl. 379/93.07

(57) ABSTRACT

A network telephone device includes a telephone host, a control module, a processing module, an audio/video output unit, and a data reader/writer. The telephone host provides general communication processes of network telephone via the information network. The control module produces recording signal and transmitting signal according to the receiving process and transmission process. The processing module executes the corresponding process of the signals received and transmitted by the telephone host respectively according to the recording signal and transmitting signal produced by the control module. The data reader/writer executes the read/write process from/to the memory unit based on the process result by the processing module, and then the audio/video output unit executes the output process based on the read/write process by the data reader/writer. Therefore, the network telephone device processes and plays audio/video information from different input sources, and thus has enhanced capabilities of multimedia process of network telephone.

### BACKGROUND OF THE INVENTION

1. Field of the Invention

This invention relates generally to network telephone technologies, and more particularly, to a network telephone device, which is capable of playing compact discs.

2. Description of Related Art

In the field of telephone development technology, from the earlier development of sound transmitting to nowadays, the telephone has the many capabilities of processing digital, sound, and images messages; in addition, many telephones enhance their capabilities via the network connection, e.g. the Public Switched Telephone Network (PSTN) and the Ethernet, which make telephones become the terminal devices of information sharing. Due to the continuing expansion of telephone capabilities, telephone has become an essential communication tool in people's daily life.

The rapid development of the network telephone brings out unexpected revolution in the telephone industry; the combination of network telephone and videophone has become the advanced research and technology of the industry. The videophone, with a bigger display screen and in accordance with some simple image recording facilities, allows the users take a look of the people on the other side while communicating with them; therefore, the videophone has the capability of displaying images.

Furthermore, along with the network videophone technology getting more advanced, big dimension display screen with high resolution quality has become very popular, thus the videophone has actually had many features of multimedia. There are some overlaps of capabilities of the audio and video process of a compact disc player and a videophone; therefore, compared with an individual videophone and a CD player, a videophone with build-in CD player is more convenient and economical and thus has a great potential in the future electronics market.

Hence, it is a highly urgent technique issue in the industry for how to provide a network telephone device that is capable of playing compact discs.

### SUMMARY OF THE INVENTION

In views of the disadvantages of the prior art mentioned above, it is a primary objective of the present invention to provide a network telephone device, which is capable of processing and playing video signals output from different sources in order to enhance the videophone with the capabilities of multimedia process.

It is another objective of the present invention to provide a network telephone device, which allows the user to record multimedia information on the network telephone device.

It is a further objective of the present invention to provide a network telephone device, which as well expands the capabilities of the videophone as saves the production cost.

To achieve the above-mentioned and other objective, a network telephone device is provided according to the present invention. The network telephone device is applicable to an information network, which consists of network telephone operation platforms. The network telephone device includes at least: a telephone host, which connects with the information network via a network interface, is capable of receiving signals transmitted from the information network and/or transmitting the received signals to the information network; a control module, which produces recording signals and transmitting signals based on the receiving processes and transmission processes of the telephone host respectively; a processing module, which executes the corresponding processes of signals received and transmitted by the telephone host according to the recording signals and transmitting signals produced by the control module; an audio/video output unit, which outputs the signals processed by the processing module; and a data reader/writer, which reads/writes information from/to a memory unit, electrically connects with as well the telephone host as the processing module via the control module, after receiving the recording signal sent from the control module, the data reader/writer saves the signals processed by the processing module in the memory unit, after receiving the transmitting signal sent from the control module, the processing module executes the process of signals accessed by the data reader/writer from the memory unit and then transmits the processed signals to the telephone host, and after that, the telephone host transmits the processed signals to the information network via network interface, wherein, when the communication between the telephone host and the information network is in an idle state and the data reader/writer activates the read action on the memory unit, the processing module executes the process of signals read by the data reader/writer, and after that, the audio/video output unit executes the signal output process.

The control module of the network telephone device according to the present invention takes control over the transmitting direction of the audio/video information, therefore, the network telephone device of the present invention is capable of building up information transmitting path with different information senders and information recipients, the transmitting direction of the audio/video information includes at least the following situations: the data reader/writer reads a compressed information, and then the processing module decompresses the compressed information, the decompressed information can be played by the network telephone or, after the process of mode conversion by the processing module, transmitted to the telephone host, and after that, the telephone host transmitted the information processed by the processing module via the network interface to the information recipient; furthermore, the telephone host reads a compressed information, and then the processing module executes the decompression process, and then the decompressed information can be played by the network telephone or, further after the process of mode conversion executed by the processing module, the data reader/writer writes the processed information in the file mode to the memory unit that is rewritable to the data reader/writer; in addition, the network telephone device receives external video information and audio information and then play the received information, or after that the processing module executes the processes of compression and mode conversion of the received external information, the processed information is transmitted to the telephone host, and after that, the telephone host transmits the information processed by the processing module via network interface to information recipient, or the processed information is saved in file mode in the memory unit that is rewritable to the data reader/writer.

In summary, compared with the individual videophone and CD player, the network telephone device of the present invention provides the videophone with the capability of playing the content saved in the compact disc, and practically enhances the videophone with the capability of multimedia process.

### BRIEF DESCRIPTION OF DRAWINGS

The present invention can be more fully understood by reading the following detailed description of the preferred embodiments, with reference made to the accompanying drawings, wherein:

FIG. 1 is a block diagram of an information network and a network telephone device according to the present invention;

FIG. 2 is a flowchart illustrating basic operating steps that the network telephone device shown in FIG. 1 records video information transmitted from the information network onto a compact disc; and

FIG. 3 is a flowchart illustrating basic operating steps that the network telephone device shown in FIG. 1 plays the video information recorded in the compact disc.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

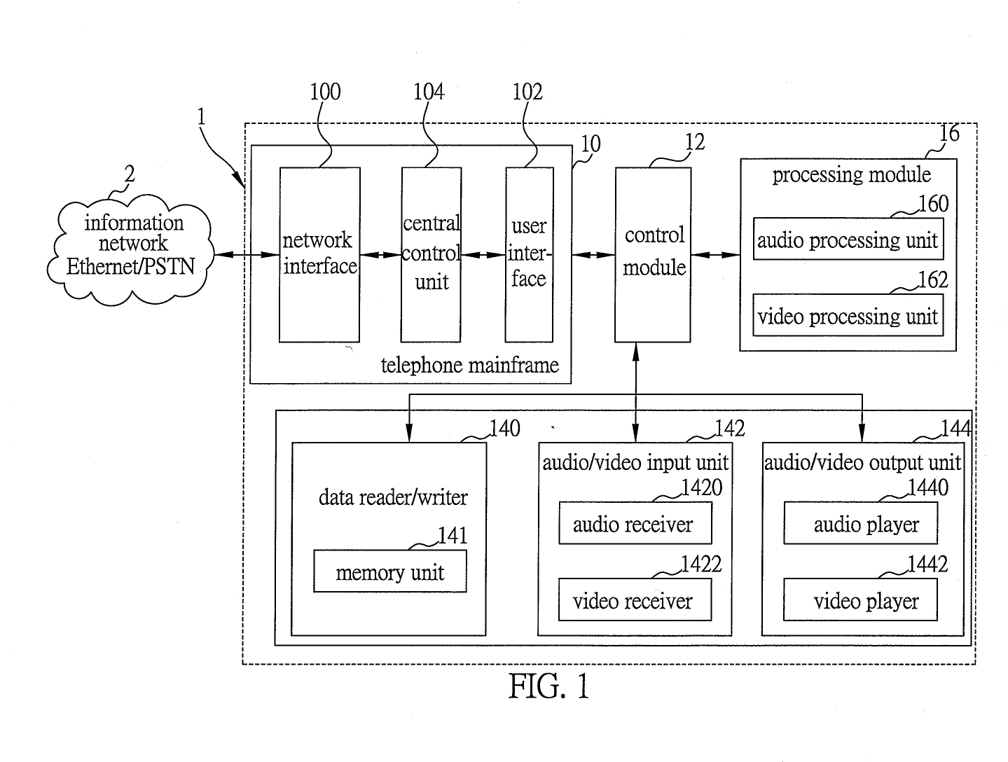

Please refer to FIG. 1, which is a block diagram of an information network 2 and a network telephone device 1 according to the present invention. The network telephone device 1 is applicable to the information network 2, which is composed of a network telephone operation platform. The network telephone device 1 comprises a telephone host 10, a control module 12, a data reader/writer 140, an audio/video input unit 142, an audio/video output unit 144, and a processing module 16. The information network 2 can be a Public Switched Telephone Network (PSTN), Ethernet, or even mobile phone service networks, such as General packet Radio Service (GPRS) and Code Division Multiple Access (CDMA), etc.

The telephone host 10 is connected to the information network 2 via a network interface 100, for receiving audio/video information transmitted from the information network 2, or transmitting the received audio/video information to the information network 2 via the network interface 100. The telephone host 10 supports various audio compression modes, such as PCM, ADPCM, SB-ADPCM, ACELP, CS-ACELP, eX-CELP, RPE-LTP, EVRC, MPEG, AC3, DTS, WMA, AAC, etc., and also various image compression modes, such as H.261, H.263, H.264, MPEG1, MPEG2, and MPEG4, etc. The telephone host 10 further comprises a user interface 102 and a central control unit 104. A user is allowed to input commands with the use of the user interface 102, which is, for example, a keyboard or a plurality of function keys, to control the network telephone device 1. The central control unit 104 controls the network interface 100 in order to process audio/video transmitting between the network telephone device 1 and the information network 2.

The control module 12 controls the selection of a plurality of audio/video information transmission paths. The control module 12 is for example a control switch that controls transmitting directions of the audio/video information. The control module 12 allows the user to take control of the network telephone device 1, and then process information transmission with different information senders or information recipients via the information network 2, and allows the user to take control of the network telephone device 1 and then process multi-media play. Wherein, based on the receiving process and transmission process of the telephone host 10, the control module 12 generates recording signals and transmitting signals respectively.

The data reader/writer 140, the audio/video input unit 142, and the audio/video output unit 144 are all electrically connected with the telephone host 10 via the control module 12, and execute corresponding transmission processes of the received audio/video information based on recording signal and transmitting signal generated by the control module 12. The data reader/writer 140 that is, e.g. a CD-rewritable disk, is for reading/writing information from/to a memory unit 141 that is, e.g. a compact disc, in the present embodiment, the data reader/writer 140 is, e.g. a CD-rewritable disk, the CD-rewritable disk can play various video compact discs, such as DVD, SVCD, DVCD, VCD, CD-R(W), DVD-R, CD-G, and JPEG, etc., and support as well various audio compression modes, such as MPEG, AC3, DTS, WMA, and AAC, as various video compression modes, such as MPEG1, MPEG2, and MPEG4, etc. The audio/video input unit 142 comprises an audio receiver 1420 and a video receiver 1422. Wherein, the audio receiver 1420 can a telephone receiver, a microphone, or a recording pen, etc., and the video receiver 1422 can be a sensor device, such as CCD and CMOS, etc. The audio/video output unit 144 comprises an audio player 1440 and a video player 1442. The audio player 1440 can be a telephone receiver, a loudspeaker, or an earphone, and the video player 1442 can be a liquid crystal display (LCD).

The processing module 16 executes respectively the corresponding processes of the audio/video information received and transmitted by the telephone host 10 based on the recording signal and transmitting signal generated by the control module 12. A general videophone comprises the processing module 16. The processing module 16 executes a digital/analog conversion (DAC) of the audio/video information received from the information sender by the telephone host 10, and after that, the audio/video output unit 144 outputs the converted audio/video information, and the conversion process may further comprises a decompression process, this is for the situation that the audio/video information received from the information network 2 is in a compressed mode, or, the processing module 16 executes the analog/digital conversion (ADC) of the audio/video information received by the audio/video input unit 142, and then the telephone host 10 transmits the converted audio/video information to the information network 2 via network interface 100, and the conversion process may further comprises a compression process to avoid an oversized transmitting audio/video file. However, in addition to the feature processes of a general videophone, such as digital/analog conversion, analog/digital conversion, and compression/decompression process, the processing module 16 of the network telephone device 1 according to the present invention, based on the recording signal and transmitting signal generated by the control module 12, further executes respectively the corresponding process of the audio/video information received and transmitted by the telephone host 10. Followed is the detailed description of the processes.

The process module 16 further comprises at least: an audio processing unit 160 and a video processing unit 162. The audio processing unit 160 is for executing the audio compression/decompression and mode conversion of the received audio information, wherein, speaking of the mode conversion, if the audio processing unit 160 determines that the file mode of the received audio information is not readable/playable by the audio player 1440 of the audio/video output unit 144 of the network telephone device 1, then the audio processing unit 160 executes mode conversion, and if the audio processing unit 160 determines that the file mode of the received audio information is readable/playable by the audio player 1440 of the audio/video output unit 144 of the network telephone device 1, there is no need of a mode conversion; in addition, the video processing unit 162 is for executing the video compression/decompression, mode conversion, and parameter adjustment of the received video information, wherein, speaking of the parameter adjustment, the video processing unit 162, based on the received video information, calculates and properly zooms up/down the vertical and/or horizontal pixels to provide a means for the video player 1442 of the audio/video output unit 144 of the network telephone device 1 to play the video information.

The control module 12 controls the network telephone device 1 based on the different information sender or information recipient to execute corresponding audio/video information process, and then based on the processed audio/video information to control the processing module 16 to execute compression/decompression and mode conversion, wherein the audio/video transmission process comprises: upon receiving a save command of the audio/video information from the user interface 102 of the telephone host 10, the control module 12 produces a recording signal, and after that, the processing module 16 executes the decompression process of the information received by the telephone host 10 according to the recording signal, and the recording signal also makes the data reader/writer 140 to execute the writing process of the information decompressed by the processing module 16, after that, the telephone host 10 reads the decompressed information that is saved in the memory unit 141 of the data reader/writer 140, and then the user can play the saved information via the audio/video output unit 144, wherein, when the network interface 100 of the telephone host 10 receives an information from the information network 2, the control module 12 immediately takes control of the processing module 16 to determine that whether the received information is compressed or not, if yes, then the processing module 16 executes the decompression process, and then the decompressed information is written to the data reader/writer 140 in file mode and then saved; in addition, the audio/video input unit 142 can collect external video signals and audio signals for the network telephone device to play, or the control module 12 produces a recording signal according to the receiving command received by the user interface 102 of the telephone host 10, after that, based on the recording signal, the processing module 16 executes the compression process of the video signals and audio signals collected by the audio/video input unit 142 and then transmits the compressed signals to information network 2 via the network interface 100 of the telephone host 10, or according to the receiving command received by the user interface 102 of the telephone host 10, the processing module 16 executes the compression process of the video signals and audio signals collected by the audio/video input unit 142, and then writes the compressed information in file mode to the memory unit 141 of the data reader/writer 140.

Furthermore, upon receiving a transmitting command of an audio/video information from the user interface 102 of the telephone host 10, the control module 12 produces a transmitting signal that makes the processing module 16 to execute the compression process of the information saved in the memory unit 141 of the data reader/writer 140 and then transmit the compressed information to the information network 2 via the network interface 100 of the telephone host 10, and after that, the information recipient receives the information.

Besides, when there is no information receiving/transmitting between the telephone host 10 and the information network 2, namely, in an idle state, the user can input an read command to the user interface 102 of the telephone host 10, in order to make the control module 12 as well take control over the data reader/writer 140 to read the information saved in the memory unit 141 as take control over the processing module 16 to process the information read by the data reader/writer 140 into a proper mode that can be outputted by the audio/video output unit 144.

Therefore, the network telephone device 1 according to the present invention enhances the information transmission process of the conventional videophone (network telephone), specifically, the network telephone device 1 according to the present invention not only can accomplish general network communication process, but also, via the display screen of general videophone and the audio/video signal conversion and without changing the original system of the videophone, can save the transmitted information and display the accessed multimedia content. Therefore, the network telephone device of the present invention practically saves production cost and meanwhile enhances the capabilities of the videophone.

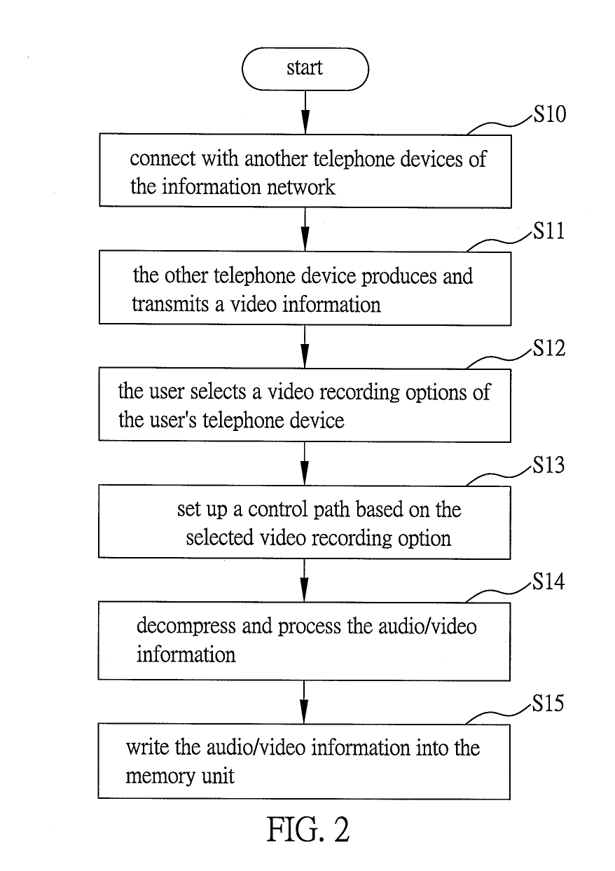

FIG. 2 is an operational flowchart, which illustrates the basic operating steps that the network telephone device 1 of the present invention saves video information transmitted from the information network 2 in the memory unit 141 (e.g. a compact disc).

In step S10, the user uses a local network telephone device 1, via the user interface 102 of the local network telephone device 1, to dial a number and connect with another network telephone device of the information network 2 (not shown), or to receive a call from another network telephone device of the information network 2. Next, proceed to step S11.

In step S11, the other network telephone device of the information network 2 produces a video information, and then the network interface 100 of the other network telephone device transmits the video information to the network interface 100 of the local network telephone device 1, and after that, the local network telephone device receives the video information, in the process of transmitting, the video information is in a mode of compressed file or digital packet. Next, proceed to step S12.

In step S12, the user uses the local network telephone device 1, via the user interface 102 of the local network telephone device 1, to select the video information transmitted from the other network telephone device 1 to record it on the local memory unit 141, wherein, the local memory unit 141 that is located on the data reader/writer 140 of the local network telephone device 1 is applicable to, e.g. a network telephone conference, etc. for recording important video information. Next, proceed to step S13.

In step S13, the local network telephone device 1 makes the control module 12, according to the receiving command transmitted from the user interface 102, to control the telephone host 10 and the data reader/writer 140 to set up a video information control path, specifically, the control module 12 controls the telephone host 10 to transmit the received information to data reader/writer 140. Next, proceed to step S14.

In step S14, the control module 12, according to the receiving command transmitted from the user interface 102, makes the processing module 16 to execute the necessary process of the video information received by the network interface 100, e.g. compression/decompression, mode conversion, etc. in order to make the received video information in a file mode readable to the network telephone device 1. Next, proceed to step S15.

In step S15, the data reader/writer 140 writes the video information processed by the processing module 16 into the memory unit 141.

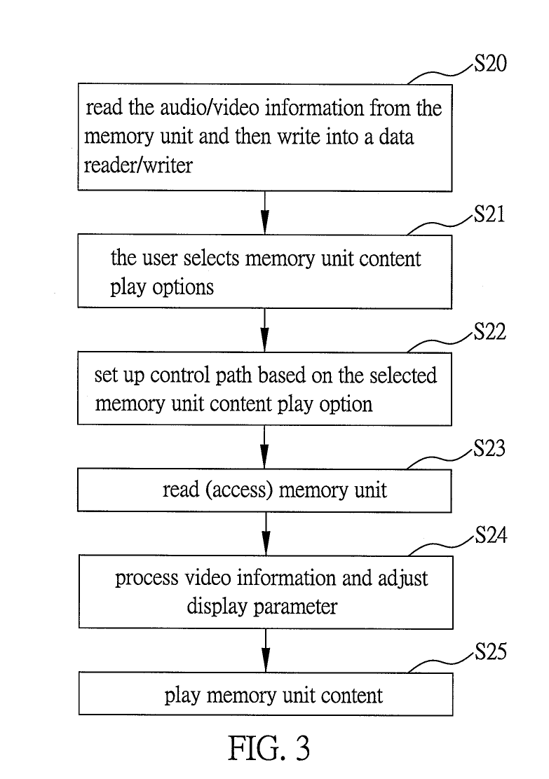

FIG. 3 is an operational flowchart, which illustrates the basic operating steps that the network telephone device 1 of the present invention plays the content saved in the memory unit 141.

In step S20, put the memory unit 141 that is to be played in the data reader/writer 140 of the network telephone device 1, the data reader/writer 140 of the present embodiment is, e.g. a rewritable CD disk, and the memory unit 141 is, e.g. a compact disc. Next, proceed to step S21.

In step S21, the user operates on the local network telephone device 1, via the user interface 102 to make the data reader/writer 140 execute the play function of the content saved in the compact disc. Next, proceed to step S22.

In step S22, the control module 12, based on the user's operation, sets up the video information control path between the data reader/writer 140 and the audio/video output unit 144, specifically, the control module 12 takes control over that the audio/video output unit 144 outputs the information read by the data reader/writer 140. Next, proceed to step S23.

In step S23, the data reader/writer 140 read the information saved in the memory unit 141. Next, proceed to step S24.

In step S24, the processing module 16 executes the decompression process and mode conversion process of the information saved in the memory unit 141, wherein, if the information comprises video information, then the processing module 16 adjusts the display dimension parameter to reach the suitable display dimension for the video player 1442 (liquid crystal display) of the network telephone device 1, and if it is necessary, then executes the process of resolution conversion of the video information. Next, proceed to step S25.

In step S25, the control module 12, according to the information content processed by the processing module 16, takes control over all the operations of the data reader/writer 140, the audio/video input unit 142, and the audio/audio output unit 144, for instance, if the information content saved in the memory unit 141 includes video information, then the control module 12 makes the video player 1442 (a liquid crystal display) play the video information saved in the memory unit 141, if the information content saved in the memory unit 141 includes audio information, then the control module 12 makes the audio player 1440 (a loudspeaker) of the network telephone device 1 play the audio information saved in the memory unit 141.

In summary, the network telephone device 1 according to the present invention is capable of processing, recording and playing signals transmitted from various audio/video sources, practically enhances the capabilities of videophones for processing multimedia. Furthermore, the network telephone device 1 according to the present invention integrates the video decompression/compression techniques of the videophone and CD player, therefore, compared with the conventional videophones, the network telephone device 1 according to the present invention has more expandable multimedia capabilities, and the expandable multimedia capabilities do not cause any difficulty in the design of the videophone, on the contrary, it does not increase the production cost of the videophone either.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A network telephone device applicable to an information network comprising a network telephone operation platform, the network telephone device comprising:
a telephone host connectable with the information network via a network interface, for receiving information transmitted from the information network and/or transmitting received information to the information network;
a control module for generating recording signal and transmitting signal respectively based on the receiving process and transmission process of the telephone host;
a processing module for executing corresponding processes of the signals received and transmitted by the telephone host respectively based on the recording signal and transmitting signal produced by the control module;
an audio/video output unit for outputting the signals processed by the processing module; and
a data reader/writer electrically connected with the telephone host and the processing module via the control module for reading/writing information from/to a memory unit, after receiving the recording signal transmitted from the control module, the data reader/writer saves the signals processed by the processing module in the memory unit, and after receiving the transmitting signal transmitted from the control module, the processing module executes the process of signals read by the data reader/writer from the memory unit, and then transmits the processed signals to the telephone host, and after that, the telephone host transmits the processed signals to the information network via the network interface, wherein, when the communication between the telephone host and the information network is in an idle state and the data reader/writer activates the read action on the memory unit, the processing module executes the process of signals read by the data reader/writer, and after that, the audio/video output unit executes the signal output process.

2. The network telephone device of claim 1, wherein the information network is either of a Public Switched Telephone Network (PSTN) and Ethernet.

3. The network telephone device of claim 1, wherein the telephone host comprises a user interface, whereby a user is allowed to input operation commands, the data reader/writer activating a read action on the memory unit based on the operation commands received by the user interface.

4. The network telephone device of claim 1, wherein the telephone host comprises a user interface, whereby a user is allowed to input operation commands, the telephone host executing the processes of receiving signal and transmitting signal based on the operation commands received by the user interface.

5. The network telephone device of claim 1, wherein the telephone host comprises a central control unit that controls the transmission process of the audio/video information of the network interface and the information network.

6. The network telephone device of claim 1, wherein the control module is a control switch that controls transmitting paths of signals after that being processed by the processing module.

7. The network telephone device of claim 1, wherein the processing module comprises:
an audio processing unit for executing audio compression/decompression and mode conversion processes on the audio information received by the telephone host, and after that, the processed information are outputted by the audio/video output unit and/or saved by the data reader/writer; and
a video processing unit for executing video compression/decompression, mode conversion, and parameter adjustment processes on the video information received by the telephone host, and after that, the processed information is outputted by the audio/video output unit and/or saved by the data reader/writer.

8. The network telephone device of claim 7, wherein first, the processing module determines whether the signals received by the telephone host is in a file mode readable to the network telephone device or not, if not, then the processing module executes the process of mode conversion.

9. The network telephone device of claim 7, wherein the video processing unit executes the video signal process that includes at least: adjusting the display parameters of display dimension and display resolution.

10. The network telephone device of claim 1, wherein the data reader/writer is a CD-rewritable disk.

11. The network telephone device of claim 10, wherein, the CD-rewritable disk supports at least one kind of the video compact discs, such as DVD, SVCD, DVCD, VCD, CD-R(W), DVD-R, CD-G, and JPEG etc.

12. The network telephone device of claim 10, wherein the CD-rewritable disk supports at least one member of the audio compression mode assembly of MPEG, AC3, DTS, WMA, and AAC.

13. The network telephone device of claim 10, wherein the CD-rewritable disk supports at least one member of the video compression mode assembly of MPEG1, MPEG2 and MPEG4.

14. The network telephone device of claim 1 further comprising an audio/video input unit.

15. The network telephone device of claim 14, wherein the audio/video input unit comprises at least an audio receiver and a video receiver.

16. The network telephone device of claim 15, wherein the audio receiver is one selected from the group consisting of a telephone receiver, a microphone, and a recording pen.

17. The network telephone device of claim 15, wherein the video receiver is either of a CCD and CMOS sensor device.

18. The network telephone device of claim 1, wherein the audio/video output unit comprises an audio player and a video player.

19. The network telephone device of claim 18, wherein the audio player is one selected from the group consisting of a telephone receiver, a loudspeaker, and an earphone.

20. The network telephone device of claim 18, wherein the video player is a liquid crystal display (LCD).

21. The network telephone device of claim 1, wherein the telephone host supports at least one member of the audio compression mode assembly of PCM, ADPCM, SB-ADPCM, ACELP, CS-ACELP, eX-CELP, RPE-LTP, EVRC, MPEG, AC3, DTS, WMA, and AAC.

22. The network telephone device of claim 1, wherein, the telephone host supports at least one member of the video compression mode assembly of H.261, H.263, H.264, MPEG1, MPEG2, and MPEG4.
